(19) United States
(12) Patent Application Publication
(10) Pub. No.: US 2008/0085016 A1
(43) Pub. Date: Apr. 10, 2008

(54) Loudspeaker Unit with an Acoustic Panel

(75) Inventor: David Magda Eddy Corynen, Dendermonde (BE)

Correspondence Address: SHEEHAN PHINNEY BASS & GREEN, PA;c/o PETER NIEVES, 1000 ELM STREET, MANCHESTER, NH, 03105-3701, US

(73) Assignees: KONINKLIJKE PHILIPS ELECTRONICS, N.V., Eindhoven (NL); PHILIPS SOUND SOLUTIONS BELGIUM N.V., Dendermonde (BE); PSS BELGIUM N.V., Dendermonde (BE)

(21) Appl. No.: 10/556,114

(22) PCT Filed: May 6, 2004
(86) PCT No.: PCT/IB04/50609

§ 371 Date: Nov. 8, 2005

(30) Foreign Application Priority Data
May 12, 2003 (EP) 03101318.8

(51) Int. Cl. H04R 25/00

(52) U.S. Cl. 381/150

(57) ABSTRACT

A loudspeaker unit comprising a frame (1), an acoustic panel (3), an electric exciter (5) for exciting the acoustic panel, and a tuning element (7). The panel suspends from the frame and has two substantially parallel main sides. The exciter is disposed at a first main side (13a) and comprises a stationary part and a translatable part, the translatable part being secured to the acoustic panel, the panel producing acoustic radiation upon energization of the exciter. The tuning element is disposed at a second main side (14a) and extends opposite the electric exciter and is connected to the frame. In order to facilitate the manufacture of the unit, the tuning element is provided with a mounting element (7a) extending through a passage in the acoustic panel, the stationary part of the electric exciter being mounted on the mounting element.

The invention relates to a loudspeaker comprising a frame, an acoustic panel suspended from the frame and having two substantially parallel main sides, an electric exciter for exciting the acoustic panel, which exciter is disposed at a first main side of said main sides and comprises a stationary part and a translatable part, the translatable part being secured to the acoustic panel, the panel producing acoustic radiation upon energization of the exciter, and a tuning element disposed at a second main side of said main sides and extending opposite the electric exciter and being connected to the frame.

PCT patent application WO 01/87002 discloses a panel-shaped loudspeaker which comprises a frame and a panel having a first main surface and a second main surface parallel to the first main surface. The loudspeaker further comprises an exciter having a translatable exciter coil mounted on a coil former secured to the panel, and a stationary magnetic unit for cooperating with the exciter coil over an air gap. When the exciter is energized, the panel is capable of sustaining bending waves and has a distribution of resonant modes of its natural bending wave vibration, which results in acoustic radiation. The loudspeaker has a disc-like tuning element extending near the second main surface of the panel and positioned opposite the exciter so as to form a resonant cavity between the panel and the exciter.

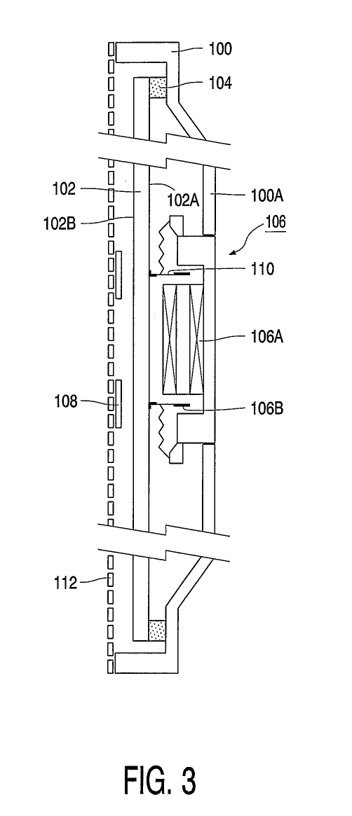

The stationary magnetic unit comprises a magnetic yoke and a permanent magnet, the coil former being suspended from the magnetic unit by means of a resilient suspension means. In practice, the magnetic unit is secured to a frame portion or to a bracket fastened to a frame. FIG. 3 of the accompanying drawings shows a panel-shaped loudspeaker with such a construction. The known loudspeaker has a frame (100) and comprises a panel (102) having a first main surface (102A) and a second main surface (102B) parallel to the first main surface. The panel is connected to the frame by means of a suspension (104). The loudspeaker further comprises an exciter (6) and a high-frequency tuning element (108). The exciter has a stationary magnetic unit (106A) and a translatable exciter coil (106B). The stationary magnetic unit is secured to a bracket (100A) attached to or being part of the frame, which bracket extends substantially parallel to the panel and is positioned opposite the first main surface. The exciter coil is mounted on a coil former (110) secured to the first main surface of the panel and suspended from the magnetic unit. The tuning element is positioned opposite the exciter and is fixed to a grid (162) which extends parallel to the panel at some distance from the second main surface. The grid is directly secured to the frame. The presence of a bracket makes the loudspeaker rather voluminous; particularly such a loudspeaker has a relatively large height over nearly the entire panel area.

In many applications, very compact loudspeaker devices are required. In such applications it is difficult to realize a sufficiently stiff mount of the exciter.

For this reason, it is an object of the invention to improve the loudspeaker unit as defined in the opening paragraph in such a way that a satisfactory mounting of the exciter can be realized, without making the loudspeaker unit voluminous.

This object is achieved with the loudspeaker according to the invention, which loudspeaker comprises a frame, an acoustic panel suspended from the frame and having two substantially parallel main sides, an electric exciter for exciting the acoustic panel, which exciter is disposed at a first main side of said main sides and comprises a stationary part and a translatable part, the translatable part being secured to the acoustic panel, the panel producing acoustic radiation upon energization of the exciter, and a tuning element disposed at a second main side of said main sides and extending opposite the electric exciter and being connected to the frame, wherein the tuning element is provided with a mounting element extending through a passage in the acoustic panel, the stationary part of the electric exciter being mounted on the mounting element. The tuning element itself improves the reproduced sound particularly at the high-range frequencies.

Due to the presence of the mounting element, a space-occupying mounting bracket known per se can be omitted for mounting the exciter. Instead, space is saved by using the mounting element, so that over a large area of the panel, particularly the area around the exciter, the loudspeaker can be extremely thin. Apart from this advantage, it has proved that the mounting of the exciter to the frame is very simple and easy, and that the obtained fastening of the exciter is very solid.

For manufacturing reasons, it is favorable to form the mounting element as an integral part of the tuning element. Suitable materials for the tuning element are e.g. metals such as aluminium, cast-aluminium or low carbon steel, and plastics, such as polyamide, acrylonitrile butadiene styrene polymer, polypropylene or polystyrene.

In a practical embodiment, the frame comprises an acoustically transparent cover, which extends at least substantially parallel to the acoustic panel, and which supports the tuning element. Such a cover may be in the form of a grid.

The manufacture of the loudspeaker can be further simplified by forming the tuning element as an integral part of the acoustically transparent cover.

In an embodiment, the mounting element is bar-shaped, particularly cylindrical. The cross-section may be circular.

Furthermore, for manufacturing reasons it is favorable to provide the stationary part of the electric exciter with a mounting hole, in which the mounting element is inserted and fastened. Fastening may be realized by a fastening means such as a click device or an adhesive, or by friction.

A favorable embodiment of the loudspeaker according to the invention is characterized in that the acoustic panel is provided with a cut-off located opposite the electric exciter and includes a membrane covering said cut-off, which membrane forms a tuning area which has a fundamental resonance frequency which is lower than the fundamental resonance frequency of any similar area in the rest of the panel, if determined under the same conditions, the passage being formed by the cut-off and an opening in the membrane.

Listening tests have revealed that the presence of such a tuning area yields a substantial improvement of the reproduced sound, particularly at the mid-range frequencies. Measurements have indicated that the better sound performance is the result of a balanced energy response.

The fundamental resonance frequency fₒ of a circular membrane area supported at its circumference is given by the equation

$${f}_{o} \approx \frac{1}{{r}^{2}} \cdot \sqrt{\frac{B}{μ}}$$

in which r is the radius (in m) of the relevant area; B is the bending stiffness (in Nm) of the material of the area; μ is the surface density (in kg/m²) of the area. The parameters which can be used to tune the fundamental resonance frequency of the membrane are thus the bending stiffness, the surface density and the radius. It was found by experiment that the best results are reached if the fundamental resonance frequency of the tuning area is lower than 1500 Hz.

Suitable materials for the membrane are e.g. certain thermoplastics, such as polyvinylchloride or glass fibre epoxies.

It has appeared that the sound performance is further improved by providing the membrane with a tuning aperture, i.e. a relatively small opening opposite the exciter. This feature particularly reduces the third harmonic distortion.

An acoustic panel that is particularly suitable for use in the loudspeaker unit according to the invention comprises two walls, which form the main sides of the panel, and a structure of parallel strip-shaped partitions which extends between the two walls and is connected to the walls. The walls and the partitions are preferably made of a material which, used in the panel, has a critical damping which is at least 2.5% of the critical damping of the relevant material, used in the panel. Mechanically, such a panel is anisotropic, wherein the panel can be relatively easily bent around an axis extending parallel to the partitions and is relatively bending-stiff about an axis oriented transversely thereto. A suitable material for the walls and the partitions is e.g. polypropylene, preferably a copolymer thereof.

A panel of the kind described above has a favorable acoustical behavior at a broad range of frequencies. If such a panel is also provided with a tuning element and a tuning area, if any, the acoustical behavior is essentially improved due to a more regular acoustic energy response.

The invention also relates to a tuning element presenting the features disclosed in any one of claims 1 to 8 and thus constructed and evidently intended for use in the loudspeaker unit according to the invention.

It is to be noted that the loudspeaker unit according to the invention is suitable for sound reproduction in hifi, home, automotive and multimedia-audio systems and is particularly suitable for applications having very small build-in depths.

With reference to the claims, it is noted that various combinations of characteristic features defined in the claims are possible.

The invention will now be described in more detail, by way of example, with reference to the drawings, in which

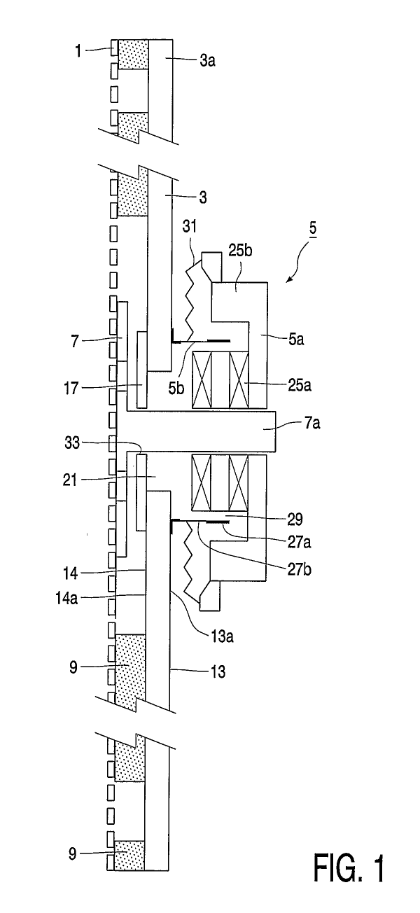

FIG. 1 shows diagrammatically in a cross-section an embodiment of the loudspeaker unit according to the invention, and

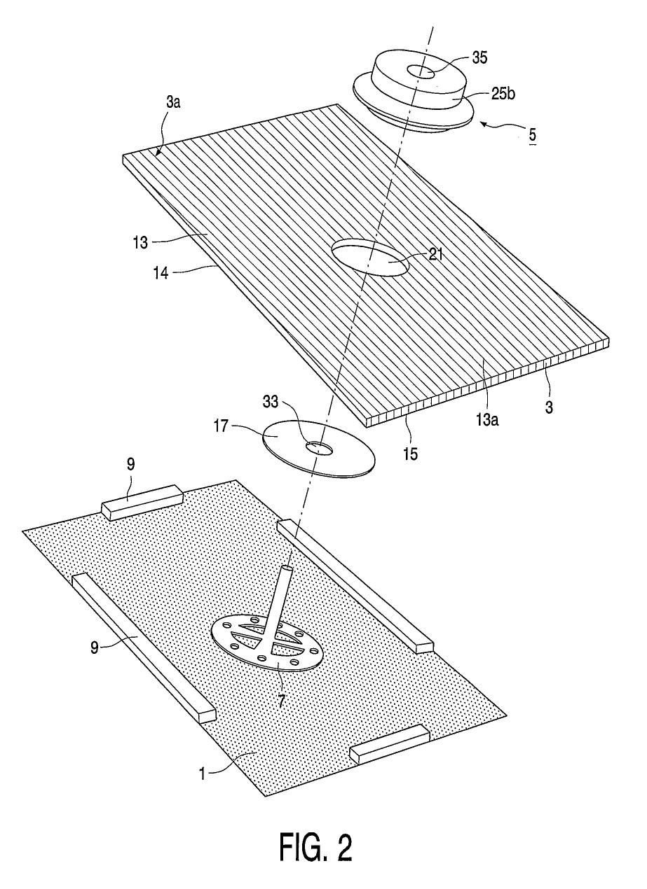

FIG. 2 is a diagrammatically exploded view of the embodiment shown in FIG. 1.

FIG. 3 shows diagrammatically a conventional loudspeaker.

The loudspeaker unit according to the invention, as shown in FIGS. 1 and 2, comprises a frame 1, an acoustic panel 3, particularly a flat panel, an electric exciter 5 and a tuning element 7. In this example, the frame 1 comprises an acoustically transparent cover, such as a grid, which extends parallel to the panel 3. The panel 3 is secured at its circumferential edge 3a to the frame 1 by means of securing strips 9, in this example adhesive strips. The strips 9 may be of a resilient or compliant material, such as soft rubber. Alternatively, a roll-collar known per se may be used instead of strips. Such a collar may be made of e.g. rubber or foam.

The panel 3 has two main sides 13a, 14a which are formed in this example by a structure having two main walls 13, 14. This structure further has parallel strip-shaped partitions 15 and is arranged and constructed as disclosed in PCT patent application WO 01/18132 (herein incorporated by reference). The walls 13, 14 and the partitions 15 form one product, manufactured by extruding a polypropylene co-polymer. Of course, other panel constructions, structures and materials are possible within the scope of the invention.

In the present embodiment, the panel 3 is provided with a tuning membrane 17 which is secured by means of a glue at the main side 13a.

The tuning membrane 17 covers a cut-off 21 provided in the panel 3 and is located opposite the exciter 5. The tuning membrane 17, which in this example is formed by a sheet of polyvinylchloride, has a fundamental resonance (about 90 Hz), which is lower than the fundamental resonance frequency of any similar area elsewhere in the panel. The exciter 5 is disposed at the main side 13 and is provided with an electromagnetic exciter system which comprises a stationary part 5a and a translatable part 5b. The stationary part 5a has a magnet system including a magnet 25a and a magnetic yoke 25b, and the translatable part tb has a coil system including an exciter coil 27a and coil former 27b on which the coil 27a is attached. The magnet system and the coil system can magnetically cooperate with each other through an air gap 29. The coil former 27b is suspended from the magnetic yoke 25b by a resilient suspension means 31 known per se and is secured to the panel 3 at the main side 14a. The tuning element 7 is located opposite the exciter 5 and the main side 13a of the panel 3 and is spaced at some distance from the main side 13a. In this embodiment, the tuning element 7 is adhered to the frame 1, but it is alternatively possible to integrate the tuning element 7 in the frame 1, i.e. in this example in the grid. The tuning element 7 is provided with a bar-like mounting element 7a which extends through a passage in the panel 3. In this example, this passage is formed by the cut-off 21 and an opening 33 in the membrane 17. The opening 33 may serve at the same time as a tuning aperture. In this example, the mounting element 7a forms an integral unit with the tuning element 7 and may be made from any suitable material, such as aluminium. The stationary part 5a of the exciter 5 is provided with a central mounting hole 35 which fits the mounting element 7a and through which hole 35 the mounting element 7a extends, the stationary part 5a being mounted on the mounting element 7a and being centered with regard to the other portions of the loudspeaker. The fixation between the exciter and the mounting element may be realized by using an adhesive or mechanical means known per se.

It is to be noted that the invention is not limited to the embodiment shown. For example, several variations are possible within the scope of the invention, notably as regards dimensions, structures and materials of the panel and the tuning element. Furthermore, an exciter of a different type, such as a piezoelectric type, may be used instead of the depicted exciter.

1. A loudspeaker unit comprising
a frame (1),
an acoustic panel (3) suspended from the frame and having two substantially parallel main sides,
an electric exciter (5) for exciting the acoustic panel, which exciter is disposed at a first main side of said main sides and comprises a stationary part and a translatable part, the translatable part being secured to the acoustic panel, the panel producing acoustic radiation upon energization of the exciter, and
a tuning element (7) disposed at a second main side of said main sides and extending opposite the electric exciter and being connected to the frame,
wherein the tuning element is provided with a mounting element (7a) extending through a passage in the acoustic panel, the stationary part of the electric exciter being mounted on the mounting element.

2. A loudspeaker unit as claimed in claim 1, wherein the mounting element is an integral part of the tuning element.

3. A loudspeaker unit as claimed in claim 1, wherein the frame comprises an acoustically transparent cover, which extends at least substantially parallel to the acoustic panel and supports the tuning element.

4. A loudspeaker unit as claimed in claim 3, wherein the tuning element is an integral part of the acoustically transparent cover.

5. A loudspeaker unit as claimed in claim 1, wherein the stationary part of the electric exciter is provided with a mounting hole, in which the mounting element is inserted.

6. A loudspeaker unit as claimed in claim 1, wherein the mounting element is bar-shaped.

7. A loudspeaker unit as claimed in claim 1, wherein the acoustic panel is provided with a cut-off located opposite the electric exciter and includes a membrane covering said cut-off, which membrane forms a tuning area, which has a fundamental resonance frequency which is lower than the fundamental resonance frequency of any similar area in the rest of the panel, if determined under the same conditions, the passage being formed by the cut-off and an opening in the membrane.

8. A loudspeaker unit as claimed in claim 7, wherein the membrane is provided with a tuning aperture.

9. A tuning element presenting the features of the tuning element defined in any one of the preceding claims and thus constructed and evidently intended for use in the loudspeaker unit as claimed in claim 1.
